(19) United States
(12) Patent Application Publication
(10) Pub. No.: US 2013/0126075 A1
(43) Pub. Date: May 23, 2013

(54) CO-MOLDED SOLE

(71) Applicant: Columbia Sportswear North America, Inc., Portland, OR (US)

(72) Inventor: Wei Yi Jiang, Zhuhai City (CN)

(73) Assignee: COLUMBIA SPORTSWEAR NORTH AMERICA, INC., Portland, OR (US)

(21) Appl. No.: 13/679,880

(22) Filed: Nov. 16, 2012

Related U.S. Application Data
(60) Provisional application No. 61/561,740, filed on Nov. 18, 2011.

(51) Int. Cl. B29C 65/02

(52) U.S. Cl. CPC B29C 65/02
USPC 156/219; 156/581

(57) ABSTRACT

Embodiments herein provide a co-molded sole for footwear, such as athletic shoes. Embodiments also provide a mold for manufacturing the co-molded sole. In various embodiments, the co-molded sole may include an outsole and a midsole. The outsole may be composed of an outsole material, and the midsole may be composed of a midsole material. The outsole and midsole may be co-molded together to form a unitary piece by the mold. The mold may include a lower plate, a middle plate, and an upper plate.

### CROSS REFERENCE TO RELATED APPLICATIONS

The present application claims priority to U.S. Provisional Patent Application No. 61/561,740, filed Nov. 18, 2011, entitled “CO-MOLDED SOLE,” the entire disclosure of which is hereby incorporated by reference.

### TECHNICAL FIELD

Embodiments herein relate to the field of footwear, and, more specifically, to footwear with molded soles.

### BACKGROUND

Many types of footwear, such as athletic shoes, include soles having an outsole and a midsole. The outsole is typically made of a relatively harder material than the midsole to provide durability and traction. The midsole is typically softer to provide cushioning and support to the user.

In a shoe manufacturing plant, the outsole and midsole are formed using separate molds. The outsole is then attached to the midsole by an adhesive. The various steps involved in manufacturing the shoe increase the time and complexity of the process. Additionally, the manufacturing process requires precise alignment of the outsole with the midsole. This can be even more complex with soles including a non-continuous outsole that includes multiple pieces. Furthermore, the adhesive between the outsole and midsole is often an area of structural weakness for the sole.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1A illustrates an exploded view of a mold for manufacturing a co-molded sole, including a lower plate, a middle plate, and an upper plate in accordance with various embodiments;

FIG. 1B illustrates a perspective view of the mold of FIG. 1A with the plates of the mold closed in accordance with various embodiments;

FIG. 2 illustrates a flow diagram of a method of manufacturing a co-molded sole in accordance with various embodiments;

FIG. 3A illustrates a partial top view of a lower plate of a mold with outsole pieces placed in respective outsole locations on a patterned portion of the lower plate in accordance with various embodiments;

FIG. 3B illustrates a partial top view of the lower plate of FIG. 3A with the middle plate in a lowered (closed) position, and with a midsole block placed in a right opening of the middle plate, in accordance with various embodiments;

FIG. 4A illustrates a bottom view of a co-molded sole in accordance with various embodiments; and

FIG. 4B illustrates a top perspective view of the co-molded sole of FIG. 4A in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In various embodiments, methods, apparatuses, and systems for a co-molded sole and a mold for making a co-molded sole are provided.

Embodiments herein provide a co-molded sole for footwear, such as athletic shoes. Embodiments also provide a mold for manufacturing the co-molded sole and a method of using the mold to manufacture the co-molded sole. In various embodiments, the co-molded sole may include an outsole and a midsole. The outsole may be composed of an outsole material, and the midsole may be composed of a midsole material. In some embodiments, the outsole material may be different from the midsole material. For example, in some embodiments, the midsole material may include a thermoplastic, such as ethylene vinyl acetate (EVA), modified EVA, and/or polyolefin. The outsole material may include a thermoplastic, thermoplastic rubber, synthetic rubber, natural rubber and/or a thermoplastic/rubber compound.

In various embodiments, the outsole and midsole may be co-molded together to form a unitary piece. The co-molding may permanently couple the midsole with the outsole while at the same time molding the midsole and/or outsole into the desired shape. In some embodiments, the co-molding may bond and/or fuse the outsole material with the midsole material to form a unitary piece without the use of an adhesive between the outsole and midsole. In other embodiments, an adhesive (e.g., an adhesive film or other adhesive) may be disposed between the midsole and outsole as a bonding interface.

The term “co-molded” as used herein may generally refer to one or more applications of molding, sculpting, cutting, carving, casting, and/or injecting of adjoining multiple layers, thereby combining the layers to form a unitary piece. The co-molding may also shape one or more of the adjoining multiple layers. The term unitary piece refers to a self-contained single object, which may include multiple layers permanently bonded and/or fused together.

In some embodiments, the outsole may be non-continuous and may include multiple outsole portions arranged on a bottom surface of the midsole and separated from one another. In these embodiments, the multiple outsole portions may be of the same material or different materials. Similarly, the multiple outsole portions may have the same or different material properties, such as hardness and/or density. In other embodiments, the outsole may be a single continuous piece of material. The material properties of the continuous piece of material may be the same or may vary over different portions of the continuous piece of material.

In various embodiments, the mold may include a lower plate, a middle plate, and an upper plate. In some embodiments, the lower plate, middle plate, and/or upper plate may be coupled to each other by one or more hinges, thereby allowing the middle plate and/or upper plate to rotate with respect to the lower plate (e.g., a “clamshell” arrangement). In some embodiments, the middle plate and upper plate may be coupled to the lower plate by the same hinge. In other embodiments, one hinge may be used to couple the middle plate to the lower plate, and a separate hinge may be used to couple the upper plate to the middle plate.

When the mold is in a closed position, the lower plate, middle plate and upper plate may be substantially parallel to and adjacent to one another. In various embodiments, the middle plate may be said to be in a closed position when the middle plate is disposed on top of the lower plate, whether or not the upper plate is open or closed. The mold may be opened by lifting the upper plate and/or the middle plate, thereby rotating the upper plate and/or middle plate about the hinge or other coupling with respect to the lower plate. In various embodiments, the mold may include one or more handles or other structures to facilitate opening, closing, and/or transporting the mold.

In various embodiments, the lower plate of the mold may include a first patterned portion in an upper surface of the lower plate. The first patterned portion may have a surface that is used to shape a bottom surface of the sole formed by the mold (i.e., the first patterned portion may correspond to the shape of the bottom surface of the sole).

The middle plate may include a body portion and an opening having a cross-sectional shape that corresponds to a cross-sectional shape of the sole. The opening may be defined by a side wall. In some embodiments, at least a portion of the side wall may be patterned to mold a side surface of the sole with a desired shape.

The upper plate may include a protruding portion that extends at least partially into the opening in the middle plate when the mold is closed. The protruding portion may include a cross-sectional shape that is similar to the cross-sectional shape in the opening in the middle plate, but slightly smaller than the cross-sectional shape of the opening to allow the protruding portion to enter the opening when the mold is closed. In some embodiments, a lower surface of the upper plate may be shaped to mold an upper surface of the sole into a desired shape.

The mold may include any suitable materials, such as aluminum and/or steel. In some embodiments, aluminum may be used to provide increased thermal conductivity compared with steel. In some such embodiments, the mold may be casted with an aluminum alloy, such as Aluminum-Magnesium (Al—Mg) alloy and/or Aluminum-Copper (Al—Cu) alloy, which may allow the mold to withstand high pressure and/or high temperature. This may increase the durability of the mold compared with a mold made only of aluminum. In other embodiments, the mold may be made of steel, which may provide increased stiffness and/or durability compared with aluminum, but with reduced heat-conductivity.

In some embodiments, the mold may be configured to form both left and right soles (e.g., for left and right feet). In these embodiments, the lower plate may include left and right patterned portions, the middle plate may include left and right openings, and the upper plate may include left and right protruding portions. In other embodiments, separate molds may be used to form the left and right soles.

In various embodiments, the same mold may be used to shape the outsole, shape the midsole, and to co-mold the outsole to the midsole to form a unitary piece. Using the single mold simplifies the process of manufacturing the soles compared with using separate molds to form the outsole and the midsole and then adhering the outsole to the midsole, such as using an adhesive. Furthermore, the mold may lower manufacturing costs, facilitate alignment between the outsole and the midsole, and/or create a stronger bond between the outsole and the midsole. In some embodiments, the mold may co-mold the outsole directly to the midsole (e.g., without an adhesive layer between the outsole and the midsole). In other embodiments, an adhesive layer may be placed between the outsole and the midsole to facilitate co-molding of the outsole to the midsole.

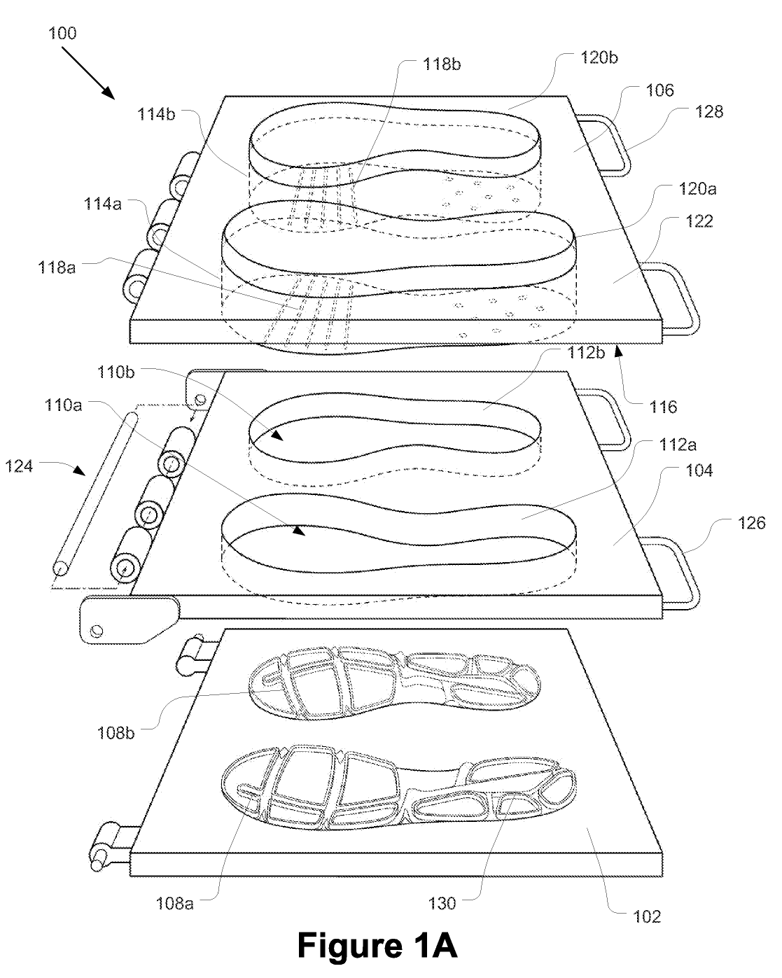

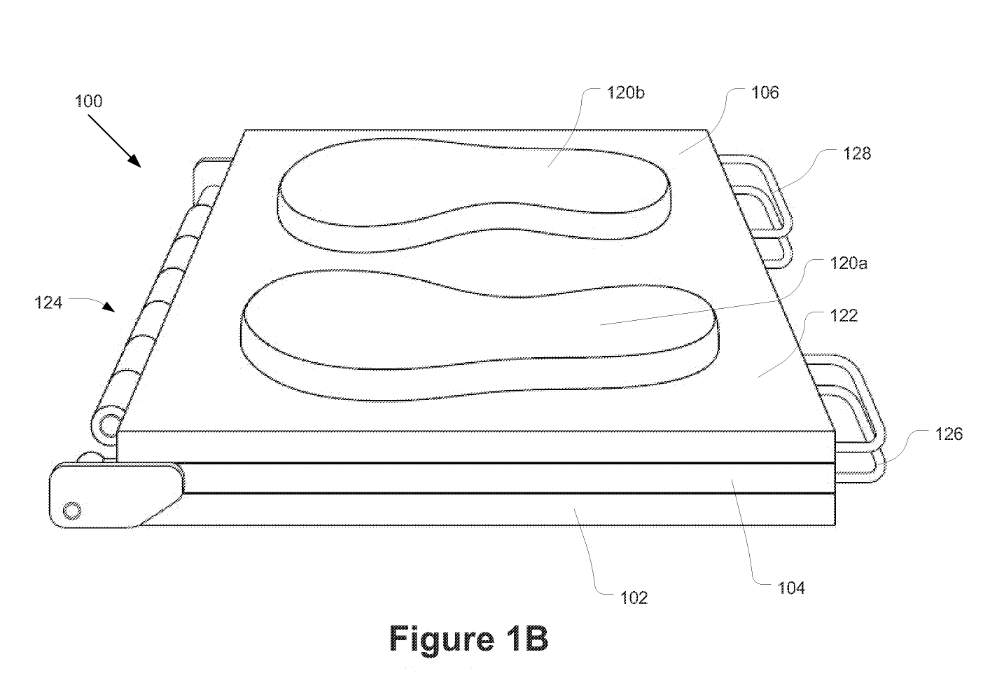

FIGS. 1A and 1B show a mold 100 in accordance with various embodiments. FIG. 1A shows an exploded view of mold 100, and FIG. 1B shows mold 100 in a closed position. Mold 100 includes a lower plate 102, a middle plate 104, and an upper plate 106. Mold 100 is configured to make both left and right soles (e.g., for left- and right-footed shoes). In other embodiments, mold 100 may be configured to make only a left or right sole.

Lower plate 102 includes a left patterned portion 108a and a right patterned portion 108b. Middle plate 104 includes a left opening 110a having a side wall 112a and a right opening 110b having a side wall 112b. The cross-sectional shape of the openings 110a-b is substantially similar to the shape of the border of the respective patterned portion 108a-b. Upper plate 106 includes a left protruding portion 114a and a right protruding portion 114b extending from a lower surface 116 of upper plate 106. The protruding portions 114a-b may include bottom surfaces 118a-b.

Protruding portions 114a-b may have a cross-sectional shape that corresponds to the cross-sectional shape of the respective opening 110a-b in middle plate 104. For example, the cross-sectional shape of the protruding portions 114a-b may be similar, but slightly smaller than, the cross-sectional shape of the respective opening 110a-b in middle plate 104. This may allow the protruding portions 114a-b to extend through at least a portion of the respective opening 110a-b when the mold 100 is closed to exert pressure on a material disposed on the patterned portions 108a-b of the lower plate 102. In some embodiments, the upper plate 106 may further include protruding portions 120a-b that extend from an upper surface 122 of upper plate 106. The protruding portions 120a-b may facilitate pressure to be exerted on material placed in the mold (e.g., on patterned portions 108a-b).

Middle plate 104 and upper plate 106 are coupled to lower plate 102 by a hinge 124, allowing middle plate 104 and/or upper plate 106 to be rotated with respect to lower plate 102 about hinge 124. When the mold 100 is in a closed position (as shown in FIG. 1B), the lower plate 102, middle plate 104, and upper plate 106 are substantially parallel to one another, with the middle plate 104 in contact with the lower plate 102, and the upper plate 106 in contact with the middle plate 104. The mold 102 may be opened by lifting the upper plate 106 and/or the middle plate 104, thereby rotating the upper plate 106 and/or middle plate 104 with respect to the lower plate 102. The middle plate 104 includes handles 126, and the upper plate 106 includes handles 128, to facilitate opening and/or closing of the mold 100.

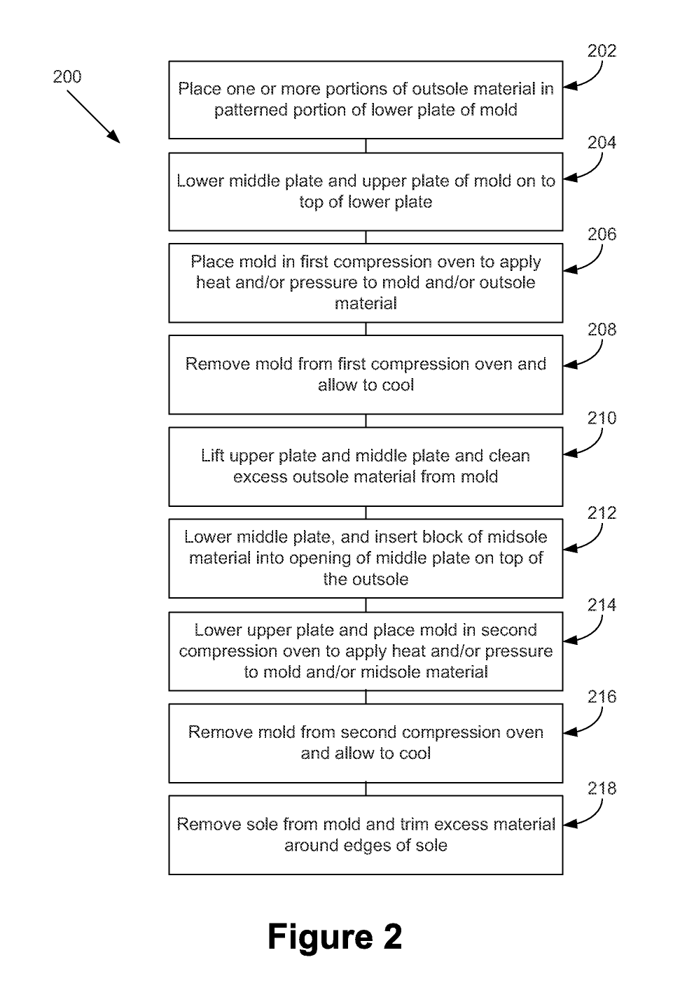

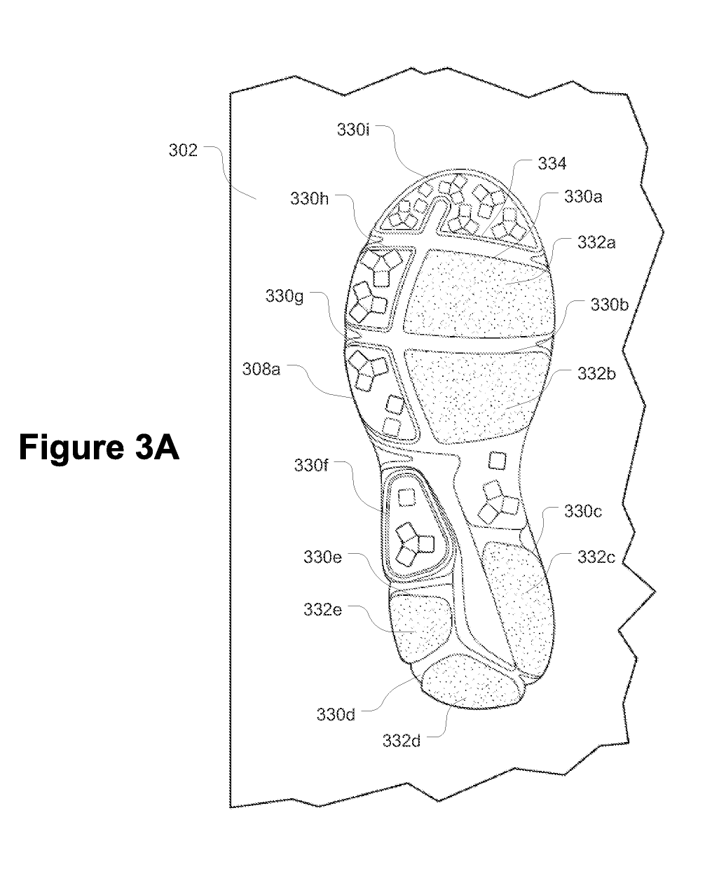

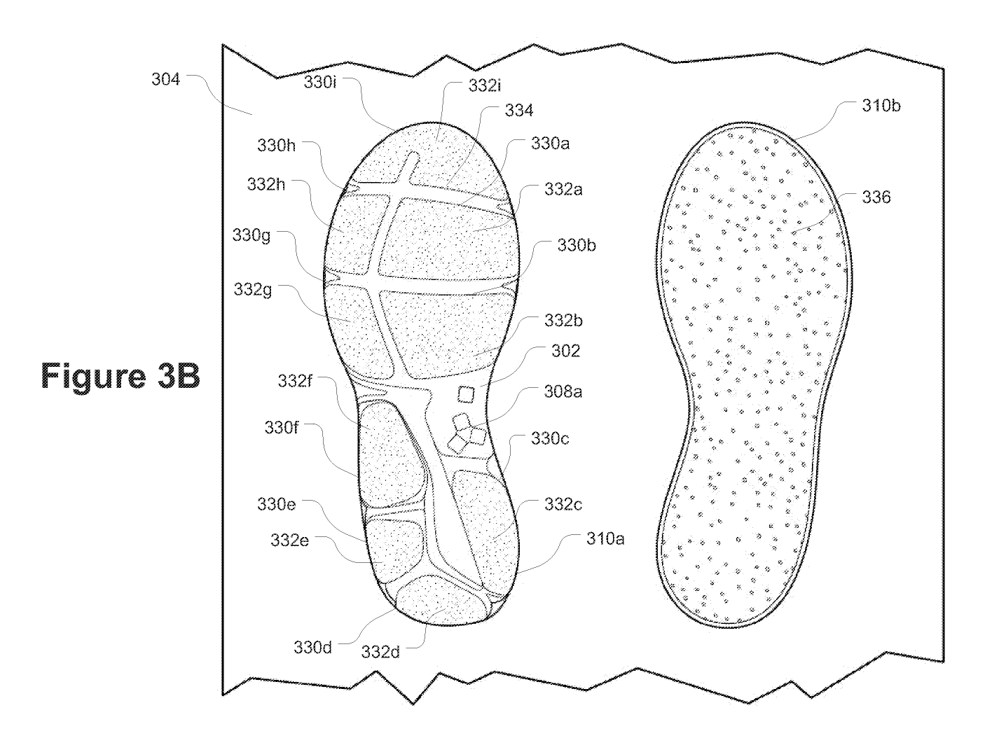

FIG. 2 illustrates a method 200 of using the mold described herein (e.g., mold 100) to form a sole in accordance with various embodiments. At 202, with the upper plate of the mold open, one or more portions of outsole material (referred to as outsole portions) are placed in designated locations of the patterned portions on the lower plate. For example, FIG. 3A shows a portion of a lower plate 302 while in the process of operation 202 of method 200. Lower plate 302 includes a left patterned portion 308a with outsole locations 330a-i. FIG. 3A shows outsole portions 332a-e in respective outsole locations 330a-e and outsole locations 330f-i empty. Other outsole portions are placed in outsole locations 330f-i as part of operation 202 of method 200.

The outsole locations 330a-i may be defined by ridges 334. Ridges 334 may also form a dam between the outsole and the midsole, as further discussed below. The outsole material may be any suitable material, such as rubber. Additionally, the outsole portions 332a-e may be of any suitable color or colors. In some embodiments, one or more of the outsole portions 332a-e may be substantially clear in color (transparent, translucent, etc.). The outsole portions 332a-e may be preformed into a suitable shape to be placed in designated locations 330a-e of patterned portion 308a.

In some embodiments, a contrasting material may be inserted in one or more designated locations of the patterned portion. The designated locations for the contrasting material may mold the contrasting material into any desirable shape, such as a word, logo, and/or other design. The contrasting material may generally be a different color than a surrounding material on the sole. Pressure may be applied to press the contrasting material into the designated location, and excess contrasting material may be wiped away. An outsole portion may then be placed on top of the contrasting material (e.g., if the contrasting material is in an outsole location 330a-i).

In other embodiments, the sole may not include a contrasting material, and these aspects of method 200 may not be included.

At 204 of method 200, the mold is closed (e.g., the upper plate is lowered on to top of the middle plate and lower plate as shown in FIG. 1B). At 206, the mold is placed in a compression oven. The compression oven may apply heat and/or pressure to the outsole portions. For example, the compression oven may apply a first set of curing conditions, e.g., pressure, temperature, and/or duration to the outsole portions. The heat and/or pressure may cause the outsole portions to conform to the shape of patterned portions of the mold and/or may cause the outsole material to cure.

The first set of curing conditions may be selected based on the outsole material used, characteristics of the mold, and/or other considerations. For example, in one embodiment, the curing duration for the outsole may be about 4 minutes. In some embodiments, the pressure applied by compression oven 124 may be about 60 to about 150 kg/cm², such as about 110 to about 120 kg/cm². In some embodiments, a lower pressure may be used (e.g., about 110 to about 120 kg/cm² or lower) than a normal curing pressure for rubber (e.g., about 140 to about 150 kg/cm²). The lower pressure may increase the usable life-span of the mold and/or allow use of an aluminum mold. In some embodiments, the outsole material (e.g., the type of rubber) may be selected to account for the lower pressure. Additionally, the mold may be designed to release air to facilitate flow of the outsole material during molding. The temperature subjected to the mold by the compression oven may be about 150 to about 180 degrees Celsius, such as about 160 to about 170 degrees Celsius. A higher temperature may facilitate molding of the outsole material by the mold.

After the outsole material and/or mold is/are subjected to the first curing conditions, the mold is removed, at 208, from the compression oven and the outsole material is allowed to cool. In some embodiments, excess outsole material may have spread beyond the designated outsole locations of the lower plate and/or onto the middle plate and/or upper plate. Accordingly, at 210, excess outsole material may be cleaned from the mold. For example, the excess material may be wiped off, such as with a cloth and/or a scraping tool.

Thereafter, at 212, with the middle plate in the closed position (e.g., lowered on top of the lower plate) and the upper plate open, a block of midsole material is placed in the openings in the middle plate. For example, FIG. 3B illustrates a portion of lower plate 302 and middle plate 304 while in the process of operation 212 of method 200. Middle plate 304 includes openings 310a and 310b. A midsole block 336 is disposed in opening 310b of middle plate 306, while opening 310a of middle plate 306 does not yet have a midsole block placed therein. FIG. 3B further shows outsole portions 332a-i after being molded as described above. A midsole block is also placed in the opening 310a of middle plate 304 as part of operation 212.

The blocks of midsole material (e.g., block 336) may be roughly shaped to fit in one or both of openings 310a-b. The midsole material may be any suitable material, such as EVA. In some embodiments, the block of midsole material may be formed by fluid posting and/or another suitable method.

In some embodiments, the midsole block may be placed directly on top of the outsole portions on the lower plate. In other embodiments, an adhesive, such as an adhesive film, may be placed between the outsole material and the block of midsole material.

At 214, after midsole blocks are placed in the openings of the middle plate, the upper plate is lowered to close the mold. The mold is then placed in a compression oven. The compression oven may be the same machine and/or a different machine from the compression oven used in operation 206. The compression oven may apply a second set of curing conditions (e.g., pressure, temperature, and/or duration) to the midsole block and/or outsole pieces as part of operation 214. In some embodiments, the second set of curing conditions may be different from the first set of curing conditions. In other embodiments, the second set of curing conditions may be the same as the first set of curing conditions. In one embodiment, the temperature and pressure of the second set of curing conditions may be the same as the temperature and pressure of the first set of curing conditions, and the curing duration of the second set of curing conditions may be longer than the curing duration of the first set of curing conditions. For example, the curing duration of the second set of curing conditions may be about 5 minutes to about 8 minutes, such as about 6 minutes.

The heat and/or pressure of the second set of curing conditions causes the midsole block to conform to the shape of the side walls of middle plate (e.g., side walls 112a-b of middle plate 104 shown in FIG. 1A) and/or the bottom surfaces of the protruding portions of upper plate (e.g., the bottom portions 118a-b of protruding portions 114a-b shown in FIG. 1A). Also, if there are exposed portions of the patterned portions of the lower plate (e.g., if the outsole does not cover the all of the patterned portions), the midsole block may conform to the shape of the exposed portions of the patterned portions on the lower plate. Additionally, the heat and/or pressure may co-mold the midsole block to the outsole portions. The co-molding may cause the midsole block to become permanently coupled (e.g., bonded and/or fused) with the outsole portions.

After the midsole material, outsole material, and/or mold is subjected to the second curing conditions, the mold is removed from the compression oven, at 216, and allowed to cool. In some embodiments, the mold may be placed in a cooling chamber to cool. Additionally, or alternatively, the mold may be cooled by circulating fluid (e.g., water) through a cooling structure built into the mold. In yet other embodiments, fluid (e.g., water) may be sprayed on the mold until the mold, midsole material, and/or outsole material reaches a desired temperature. For example, the mold may be placed in a cooling station and water may be sprayed on the mold for about 7 to about 10 minutes.

After cooling, at 218, the mold may be opened and the sole may be removed. There may be excess portions of the midsole material and/or outsole material around the edges of sole. In that case, the excess portions may be trimmed.

In other embodiments, the outsole pieces and midsole block may be shaped and co-molded together in a single molding/curing step. That is, the one or more outsole portions may be placed in the patterned portion of lower plate, and the midsole block may be placed on top of the outsole portions. The mold may then be closed and placed in a compression oven to apply heat and/or pressure to the mold, outsole portions, and/or midsole block. The outsole portions and/or midsole block may be shaped by the patterned portions of the lower plate, the side walls of the middle plate, and/or the protruding portions of the upper plate. Additionally, the midsole block may bond and/or fuse with the outsole portions to form a unitary piece.

In some embodiments in which the midsole is co-molded to the outsole without an adhesive layer between the midsole and the outsole, the outsole material and/or midsole material may have material properties selected to facilitate the co-molding without an adhesive. For example, the outsole material may be a rubber having a hardness of about 50 Shore A (50A) to about 75A, or more specifically about 60A to about 70A. The midsole material may be EVA having a hardness of about 45 Asker C to about 75 Asker C, such as about 60 Asker C. The hardness of the midsole material may facilitate applying pressure from the midsole material to the outsole material to facilitate bonding between the midsole material and the outsole material.

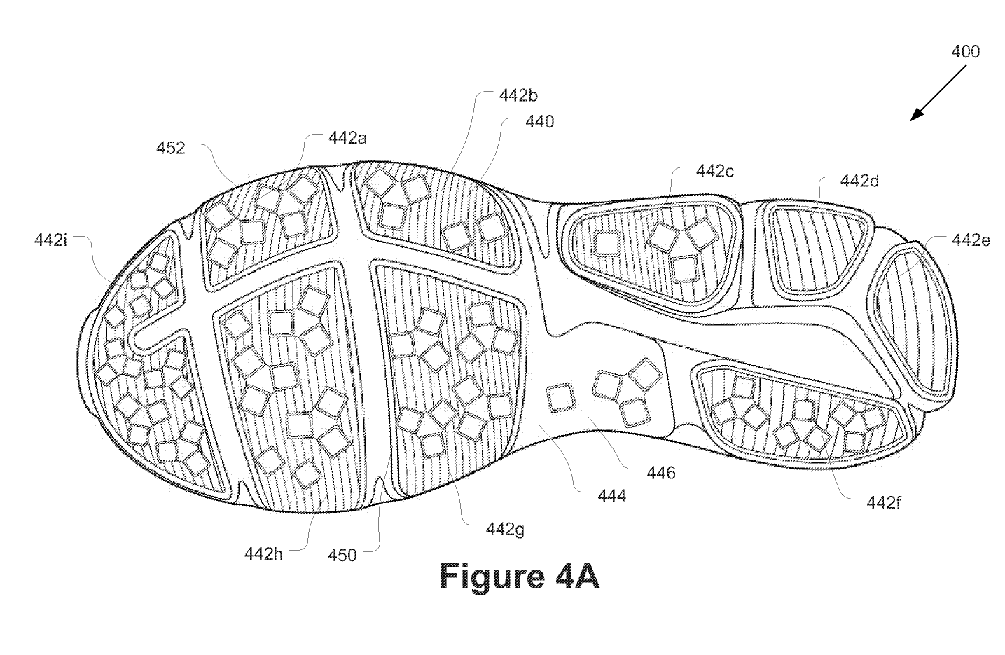

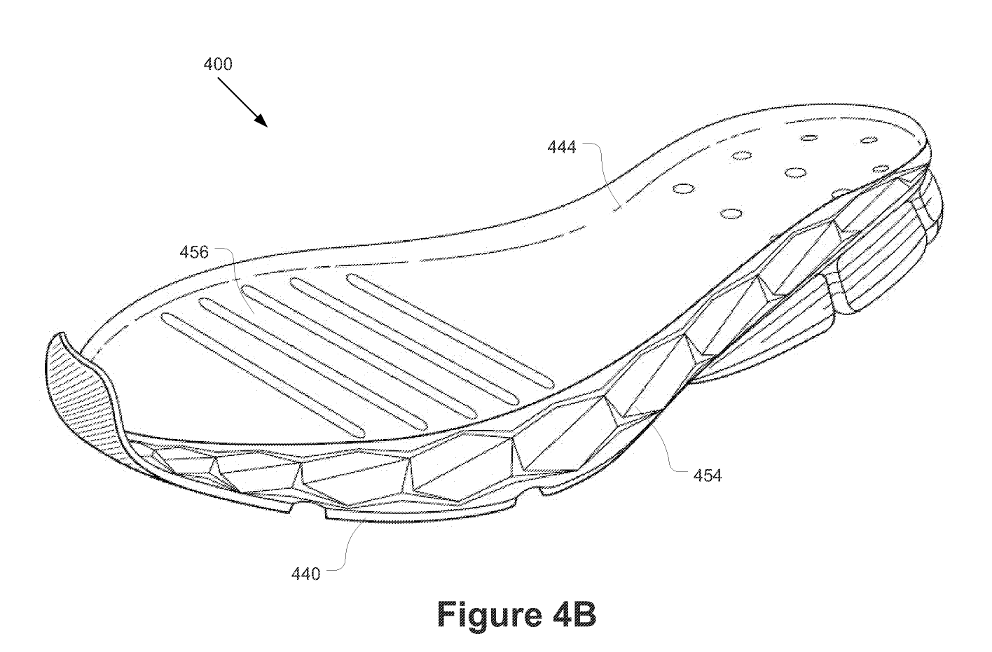

FIGS. 4A and 4B show a co-molded sole 400 in accordance with various embodiments. Sole 400 may be formed by method 200. The co-molded sole 400 is for a left-footed shoe. Co-molded sole 400 includes a discontinuous outsole 440 including a plurality of outsole portions 442a-i. Sole 400 further includes a midsole 444 that is coupled to the outsole portions 442a-I by co-molding, as described herein.

As shown in FIG. 4A, the separate outsole portions 442a-i do not collectively cover a bottom surface 446 of the sole 400 entirely. Accordingly, the midsole 444 makes up a portion of the bottom surface 446. In other embodiments, the outsole 440 may be continuous and/or may substantially cover the entire bottom surface 446 of the sole 400.

The sole 400 further includes a dam 450 that borders the outsole portions 442a-i and is recessed from the surface of midsole 444. In some embodiments, the dam 450 may have a depth (the distance from the surface of midsole 444 to the bottom of dam 450) and a width (the distance the dam 450 extends from the edges of outsole 440). In some embodiments, the depth of the dam 450 may be about 1 to about 3 millimeters (mm), such as about 1.5 mm. The width of the dam 450 may be about 1 to about 2 mm, such as about 1.5 mm. Dam 450 may prevent/reduce the color of outsole 440 from bleeding onto the surface of the midsole 444 beyond the dam 450. Dam 450 may be formed by ridges (e.g., ridges 334 shown in FIG. 3A) in the patterned portions of the lower plate around the designated outsole locations. Other embodiments may not include a dam or may include a dam of reduced width and/or depth.

The outsole 440 and/or midsole 444 may also include a sidewall parting line 452 at the edges of sole 400. The sidewall parting line 452 of the outsole 440 and/or midsole 444 may be substantially smooth and/or straight to facilitate trimming of excess material around the edges of sole 400.

As shown in FIG. 4B, the midsole 444 includes sides 454 that are shaped by the middle plate of the mold (e.g., side wall 112a of middle plate 104 shown in FIG. 1A). Midsole 444 further includes an upper surface 456 that is shaped by the protruding portion of the upper plate of the mold (e.g., protruding portion 114a of upper plate 106 shown in FIG. 1A).

Although embodiments herein have been described using a mold to co-mold a midsole and an outsole, the methods and apparatuses described herein may be used to co-mold any two or more layers of material. In some embodiments, a third element, such as a hard plastic shank, may be co-molded together with the midsole and the outsole.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A method for manufacturing a sole of footwear comprising:
placing one or more outsole portions on a patterned portion of a lower plate of a mold, the mold further including a middle plate having an opening corresponding to the patterned portion and a top plate with a protruding portion that extends into the opening when the mold is closed;
placing a midsole block in the opening of the middle plate on top of the one or more outsole portions;
closing the mold; and
applying heat and/or pressure to the midsole block to shape the midsole block and to bond the midsole block to the one or more outsole portions.

2. The method of claim 1, further comprising, prior to the placing the midsole block in the opening of the middle plate:
applying heat and/or pressure to the one or more outsole portions to shape the one or more outsole portions.

3. The method of claim 2, wherein a first set of curing conditions applied to the one or more outsole portions prior to placing the midsole block in the opening of the middle plate differs from a second set of curing conditions applied to the midsole block.

4. The method of claim 2, further comprising removing excess outsole material after applying the heat and/or pressure to the one or more outsole portions.

5. The method of claim 1, wherein the one or more outsole portions include a plurality of separate outsole portions, and wherein placing the outsole portions on the patterned portion includes placing the outsole portions in designated outsole locations on the patterned portion.

6. The method of claim 1, wherein a side surface of the opening in the middle plate is patterned to shape the midsole block.

7. The method of claim 1, wherein the midsole block has a hardness of about 45 Asker C to about 75 Asker C.

8. A mold for manufacturing a sole of footwear having an outsole and a midsole, the mold comprising:
a bottom plate having a patterned portion configured to receive an outsole material and to shape the outsole material;
a middle plate configured to be selectively brought into a closed position on top of the bottom plate, the middle plate having an opening corresponding to a border of the patterned portion and configured to receive a midsole material; and
a top plate configured to be selectively brought into a closed position on top of the middle plate, wherein the top plate includes a protruding portion that extends into the opening of the middle plate when the top plate is in the closed position to apply pressure to the midsole material to shape the midsole material and to bond the midsole material to the outsole material.

9. The mold of claim 8, wherein the patterned portion includes a plurality of outsole regions that are separated from one another, wherein the outsole regions are configured to receive separate portions of the outsole material.

10. The mold of claim 8, wherein the opening of the middle plate includes a side surface that is patterned to shape a side surface of the sole.

11. The mold of claim 8, wherein a bottom surface of the protruding portion of the top plate is shaped to form a top surface of the sole.

12. The mold of claim 8, wherein the upper plate and middle plate are coupled to the lower plate by a same hinge.

13. The mold of claim 8, wherein the protruding portion is a first protruding portion, and wherein the upper plate includes a second protruding portion extending from an upper surface of the upper plate, the second protruding portion disposed above the first protruding portion to facilitate applying pressure to the midsole material and/or outsole material.

14. The mold of claim 8, wherein the mold is further configured to transfer heat to the outsole material and/or midsole material to shape the outsole and/or midsole, respectively.
